(19) United States
(12) Patent Application Publication
(10) Pub. No.: US 2010/0146967 A1
(43) Pub. Date: Jun. 17, 2010

(54) EMISSION SYSTEM, APPARATUS, AND METHOD

(76) Inventors: Alexander Simpson, Munich (DE); Rodrigo Rodriguez Erdmenger, Munchen (DE)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(21) Appl. No.: 12/333,841

(22) Filed: Dec. 12, 2008

(51) Int. Cl. F02B 33/44

(52) U.S. Cl. 60/605.2; 290/52

(57) ABSTRACT

A system, apparatus, and method for exhaust gas recirculation (EGR) is disclosed. The EGR apparatus includes an EGR circuit having an input configured to receive an exhaust gas from an engine exhaust port, an output configured to return the exhaust gas to an intake port of the engine, and an EGR path configured to circulate the exhaust gas between the input and the output. The EGR apparatus also includes an expansion turbine connected to the EGR circuit in the EGR path downstream of the input to receive the exhaust gas, the expansion turbine configured to expand the exhaust gas and reduce a pressure thereof. The EGR apparatus further includes an EGR compressor connected to the EGR path downstream of the expansion turbine and decoupled from the expansion turbine, the EGR compressor configured to compress the exhaust gas for circulation to the output.

### BACKGROUND

1. Technical Field

The invention includes embodiments that relate to an engine exhaust emission reduction system. Embodiments of the invention relate to vehicles, locomotives, generators, and the like. Embodiments of the invention relate to a method of controlling engine exhaust system emissions.

2. Discussion of Art

Production of emissions from mobile and stationary combustion sources such as locomotives, vehicles, power plants, and the like, contribute to environmental pollution. One particular source of such emissions are nitric oxides (NOₓ), such as NO or NO₂, emissions from vehicles, locomotives, generators, and the like. Environmental legislation restricts the amount of NOₓ that can be emitted by vehicles. In order to comply with this legislation, exhaust gas recirculation (EGR) system have been implemented to reduce the amount of NOₓ emissions. However, existing EGR systems are limited in their design and efficiency for operation of the combustion sources under various operating conditions.

As such, it may be desirable to have a system that has aspects and features that differ from those that are currently available. Further, it may be desirable to have a method that differs from those methods that are currently available.

### BRIEF DESCRIPTION OF THE INVENTION

Aspects of the invention provide an exhaust gas recirculation (EGR) apparatus including an EGR circuit having an input configured to receive an exhaust gas from an engine exhaust port, an output configured to return the exhaust gas to an intake port of the engine, and an EGR path configured to circulate the exhaust gas between the input and the output. The EGR apparatus also includes an expansion turbine connected to the EGR circuit in the EGR path downstream of the input to receive the exhaust gas, the expansion turbine configured to expand the exhaust gas and reduce a pressure thereof. The EGR apparatus further includes an EGR compressor connected to the EGR path downstream of the expansion turbine and decoupled from the expansion turbine, the EGR compressor configured to compress the exhaust gas for circulation to the output.

Aspects of the invention also provide an engine system that includes an engine having an intake manifold and an exhaust manifold, an exhaust conduit connected to the exhaust manifold to convey an exhaust gas away from the engine, and a turbocharger having a turbine and a compressor driven by the turbine, wherein the turbine is connected to the exhaust conduit to receive the exhaust gas from the exhaust manifold and wherein the compressor is positioned upstream of, and connected to, the intake manifold. The engine system also includes an exhaust gas recirculation (EGR) system connected to the exhaust conduit to receive at least a portion of the exhaust gas from the exhaust conduit. The EGR system includes an EGR conduit connected to the exhaust conduit to receive the at least a portion of the exhaust gas, an expander connected to the EGR conduit and configured to expand the at least a portion of the exhaust gas and reduce a pressure thereof, a heat exchanger connected to the EGR conduit downstream of the expander to cool the at least a portion of the exhaust gas, and an EGR compressor connected to the EGR conduit downstream of the heat exchanger and configured to compress the at least a portion of the exhaust gas for recirculation to the intake manifold of the engine.

Aspects of the invention also provide a method that includes the steps of conveying exhaust gas from an exhaust manifold of an internal combustion engine to an exhaust gas recirculation (EGR) system, expanding the exhaust gas in an expansion turbine in the EGR system to lower a temperature and to generate a mechanical power output, and selectively transferring the expanded exhaust gas to an EGR compressor in the EGR system positioned downstream from the expansion turbine. The method also includes the steps of compressing the exhaust gas in the EGR compressor to a desired pressure independently of the mechanical power output of the expansion turbine and recirculating the compressed exhaust gas to an intake manifold of the internal combustion engine.

Various other features may be apparent from the following detailed description and the drawings.

### BRIEF DESCRIPTION OF THE DRAWINGS

The drawings illustrate at least one preferred embodiment presently contemplated for carrying out the invention.

In the drawings:

FIG. 1 is a schematic diagram of an internal combustion engine system incorporating an exhaust gas recirculation (EGR) system according to an embodiment of the invention.

FIG. 2 is a schematic diagram of an internal combustion engine system incorporating an EGR system according to an embodiment of the invention.

FIG. 3 is another schematic diagram of an internal combustion engine system incorporating an EGR system according to an embodiment of the invention.

### DETAILED DESCRIPTION

The invention includes embodiments that relate to engine emission reduction systems. The invention includes embodiments that relate to an apparatus for controlling the emissions of an engine. The invention includes embodiments that relate to a method of controlling the emissions of an engine.

Embodiments of the invention provide an exhaust gas recirculation (EGR) apparatus including an EGR circuit having an input configured to receive an exhaust gas from an engine exhaust port, an output configured to return the exhaust gas to an intake port of the engine, and an EGR path configured to circulate the exhaust gas between the input and the output. The EGR apparatus also includes an expansion turbine connected to the EGR circuit in the EGR path downstream of the input to receive the exhaust gas, the expansion turbine configured to expand the exhaust gas and reduce a pressure thereof. The EGR apparatus further includes an EGR compressor connected to the EGR path downstream of the expansion turbine and decoupled from the expansion turbine, the EGR compressor configured to compress the exhaust gas for circulation to the output.

Embodiments of the invention provide an engine system that includes an engine having an intake manifold and an exhaust manifold, an exhaust conduit connected to the exhaust manifold to convey an exhaust gas away from the engine, and a turbocharger having a turbine and a compressor driven by the turbine, wherein the turbine is connected to the exhaust conduit to receive the exhaust gas from the exhaust manifold and wherein the compressor is positioned upstream of, and connected to, the intake manifold. The engine system also includes an exhaust gas recirculation (EGR) system connected to the exhaust conduit to receive at least a portion of the exhaust gas from the exhaust conduit. The EGR system includes an EGR conduit connected to the exhaust conduit to receive the at least a portion of the exhaust gas, an expander connected to the EGR conduit and configured to expand the at least a portion of the exhaust gas and reduce a pressure thereof, a heat exchanger connected to the EGR conduit downstream of the expander to cool the at least a portion of the exhaust gas, and an EGR compressor connected to the EGR conduit downstream of the heat exchanger and configured to compress the at least a portion of the exhaust gas for recirculation to the intake manifold of the engine.

Embodiments of the invention provide a method that includes the steps of conveying exhaust gas from an exhaust manifold of an internal combustion engine to an exhaust gas recirculation (EGR) system, expanding the exhaust gas in an expansion turbine in the EGR system to lower a temperature and to generate a mechanical power output, and selectively transferring the expanded exhaust gas to an EGR compressor in the EGR system positioned downstream from the expansion turbine. The method also includes the steps of compressing the exhaust gas in the EGR compressor to a desired pressure independently of the mechanical power output of the expansion turbine and recirculating the compressed exhaust gas to an intake manifold of the internal combustion engine.

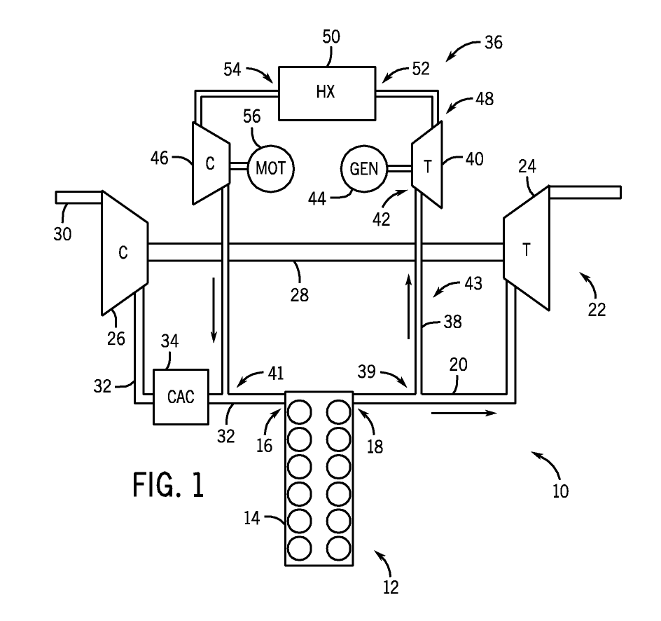

Referring to FIG. 1, a schematic illustration of an internal combustion engine system generally designated 10 is illustrated. The internal combustion engine system includes both mobile applications (e.g., automobiles, locomotives) and stationary applications (e.g., power plants). For ease in discussion, the internal combustion engine system 10 is discussed hereinafter in relation to a compression ignition engine system with the understanding that the discussion can readily be applied to other systems (e.g., systems that employ both spark ignition and compression ignition). The internal combustion engine system 10 comprises an engine 12, which includes an engine body 14, an air intake manifold 16, and an exhaust manifold 18. The air intake manifold 16 serves to deliver intake air (e.g., an oxygen-containing gas) to combustion chambers (e.g., cylinders) in the engine body 14 via intake valves (not shown). That is, the intake manifold 16 is connected with the combustion chambers to deliver intake air thereto. During operation, a fuel from a fuel source (not shown) is introduced into the combustion chambers. The type of fuel varies depending on the application. However, suitable fuels include hydrocarbon fuels such as gasoline, diesel, ethanol, methanol, kerosene, jet fuel, and the like; gaseous fuels, such as natural fluid, propane, butane, and the like; and alternative fuels, such as hydrogen, biofuels, dimethyl ether, synthetic fuels, and the like; as well as combinations comprising at least one of the foregoing fuels. The fuel is then combusted with the oxygen-containing gas to generate power.

The exhaust manifold 18 of the engine 12 is connected with the combustion chambers and serves to collect the exhaust gases generated by the engine 12. The exhaust manifold 18 is also connected with an exhaust conduit 20, which is further connected with a turbocharger 22. The turbocharger 22 includes therein a turbine 24 and a compressor 26, such as a centrifugal compressor. In one embodiment, a turbine wheel of the turbine 24 is coupled to compressor 26 by way of a drive shaft 28. During operation, the exhaust gases from exhaust conduit pass through the turbine 24 and cause the turbine wheel to spin, which causes the drive shaft 28 to turn, thereby causing the compressor wheel of the compressor 26 to spin. The centrifugal compressor 26 draws in air at the center of the compressor wheel and moves the air outward as the compressor wheel spins. Ambient air enters the compressor 26 through an intake 30, and compressor 26 works to compress the air so as to provide an increased mass of air to the intake manifold 16 of engine 12. The compressed air from compressor 26 is supplied to an intake air conduit 32 to transfer the fresh air to the intake manifold 16, which in turn supplies the combustion chambers of engine 12. Connected to intake air conduit 32 downstream of compressor 26 and upstream from intake manifold 16 is a charge air cooler 34. Charge air cooler 34 cools the fresh/ambient air after exiting the compressor 26 of turbocharger 22 before it enters intake manifold 16. Meanwhile, the exhaust gas supplied to the turbine 24 is discharged to the atmosphere.

Also included in internal combustion engine system 10 is an exhaust gas recirculation (EGR) system 36. The EGR system 36 is connected to exhaust conduit 20 and receives a portion of the exhaust gases generated by engine 12 to be passively routed for introduction into the intake air conduit 32 to intake manifold 16. As shown in FIG. 1, according to an embodiment of the invention, an EGR conduit 38 branches off of exhaust conduit 20 at a location downstream of the exhaust manifold 18 and upstream of the turbine 24 of turbocharger 22. An input 39 of EGR conduit 38 receives exhaust gas from exhaust conduit 20. The exhaust gas is received at input 39 and circulated through the EGR system 36 by the EGR conduit 38, which forms an exhaust path by which to transfer the gas to an outlet 41 of EGR conduit 38 and out therefrom into the intake air conduit 32 for return to the intake manifold 16 of the engine 12, thus forming an EGR circuit 43.

A portion of the exhaust gas enters into EGR system 36 through inlet 39 and is directed through EGR conduit 38 to an expansion turbine 40 (i.e., expander), which receives the exhaust gas through an inlet 42 connected to EGR conduit 38. The exhaust gas received by expansion turbine 40 is at an elevated temperature, as it is received directly from exhaust manifold 18 of engine 12, and the expansion turbine 40 works to expand the exhaust gas to decrease the temperature thereof. The expansion of the exhaust gas produces work that is turned into power by the expansion turbine 40 in the form of a mechanical power output. As shown in FIG. 1, according to one embodiment of the invention, the mechanical power output generated by expansion turbine 40 is transferred to a generator 44 that is connected thereto, such that the generator will generate electrical power. The electrical power from generator 44 can be used to power various components in the internal combustion engine system 10, including an EGR compressor 46 positioned downstream from the expansion turbine 40 (by way of an electric motor), as will be explained in greater detail below. The amount of power generated by expansion turbine and transferred to generator 44 will vary according to the specific configuration of internal combustion engine system 10, but can be used to compensate for the power requirements of the motor.

Referring still to FIG. 1, after the exhaust gas is expanded and cooled by expansion turbine 40, it exits an outlet 48 of the expansion turbine and is transferred by way of EGR conduit 38 to a heat exchanger 50. The heat exchanger 50 has an inlet end 52 that is in fluid communication with the exhaust manifold 18. The heat exchanger 50 further cools the exhaust gas that is passed from the exhaust manifold 18 of the engine 12 and through the expansion turbine 40. Cooling of the “hot” exhaust gas is accomplished by the heat exchanger 50 using techniques that are well known in the art. The heat exchanger can be configured, for example, as a counter-flow primary surface heat exchanger, a water cooled heat exchanger, or an oil cooled heat exchanger. Beneficially, the size/volume of heat exchanger 50 can be significantly reduced (e.g., reduced by 50%) as compared to heat exchangers typically used in an EGR system. That is, as the exhaust gas is cooled to an extent as it passes through expansion turbine 40, heat exchanger 50 can be downsized, as a smaller amount of additional cooling is required thereby.

Upon further cooling by heat exchanger 50, the “cooled” exhaust gas exits the heat exchanger 50 at an outlet end 54 and is transferred to the EGR compressor 46 by EGR conduit 38. EGR compressor 46 functions to compress the exhaust gas to an acceptable level for transfer to the intake manifold 16 according to a forced air induction intake method. As the exhaust gas was expanded upon passage through the expansion turbine 40, the pressure of the exhaust gas requires compression work to be introduced into the intake manifold 16. Thus, EGR compressor 46 is configured to compress the exhaust gas. According to the embodiment of FIG. 1, power generated by expansion turbine 40 is used to drive the EGR compressor 46 to achieve such an increased pressure ratio. That is, power from the generator 44 is transferred to an electric motor 56, which operates at variable speeds/power outputs to supply a controlled power to the EGR compressor 46. The power provided from expansion turbine 40 is sufficient to allow for operation of the EGR compressor 46 within a large range of operating conditions. Beneficially, as the expansion turbine 40 operates independently (i.e., is decoupled) from the EGR compressor 46, the power output of expansion turbine 40 is not directly transmitted to the EGR compressor 46. Instead, the generator 44 and electric motor 56 provide for variable operation of the EGR compressor 46 independent from the expansion turbine 40, allowing the EGR compressor to operate with an increased degree of versatility and operate to produce a varied compression ratio as needed/desired by the internal combustion engine system 10.

Once the exhaust gas is compressed a target amount by the EGR compressor 46, the exhaust gas exits the EGR compressor via EGR conduit 38. As shown in FIG. 1, EGR conduit 38 joins with the intake air conduit 32 downstream of charged air cooler 34 to mix exhaust gas with ambient air. It is also envisioned, however, that EGR conduit 38 could join with the intake air conduit 32 upstream of the charged air cooler 34. Thus, the exhaust gas circulated through EGR system 36 is mixed with fresh intake air provided from the turbocharger 22, and the mixture is transferred to intake manifold 16.

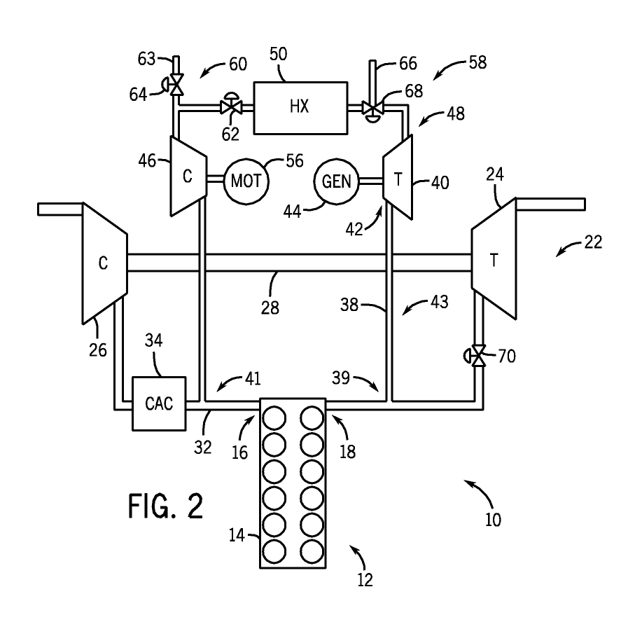

Referring now to FIG. 2, according to another embodiment of the invention, an EGR system 58 includes therein a valve system 60 positioned in the EGR conduit 38 to control an intake (i.e., injection) of ambient air into the EGR system 58 and control the flow of exhaust gas through the EGR system. During various modes of operation of internal combustion engine system 10, it is desirable to vary the intake of ambient (i.e., fresh) air and exhaust gas into the EGR compressor 46. For example, during part loads, cold start, and transient operation of the internal combustion engine system 10, it is desirable to provide an increased intake of fresh air to intake manifold 16 of engine 12. In such operational modes, the benefits of recirculating the exhaust gas back to the intake manifold 16 can be minimal (i.e., minimal emissions reductions from EGR) in comparison with the advantages of having an increased charging pressure in the intake manifold 16.

Thus, referring to FIG. 2, an EGR valve 62 is positioned in EGR conduit 38 upstream of EGR compressor 46 and, according to one embodiment, downstream of heat exchanger 50. When it is desired to provide EGR compressor 46 with ambient air, EGR valve 62 is closed to block exhaust gas from flowing to the EGR compressor and cut-off the flow of exhaust gas through the EGR system 58. To provide ambient air to EGR compressor 46, an air intake circuit 63 (i.e., ambient air intake conduit) having an air intake is provided to EGR system 58 and includes therein an intake valve 64 for controlling the amount of ambient air introduced into EGR system 58. In an open position, intake valve 64 allows for the injection of ambient air into the EGR system 58 through air intake conduit 63. While valve system 60 is shown in FIG. 1 as comprising a separate EGR valve 62 and intake valve 64, it is also recognized that a single valve could be positioned at an intersection of the EGR conduit 38 and the air intake conduit 63, to control the flow of exhaust gas and injection of ambient air.

As further shown in the embodiment of FIG. 2, a secondary EGR valve 68 can be positioned in EGR conduit 38 to control venting of exhaust gas into a secondary exhaust conduit or circuit 66, which joins with EGR conduit 38 upstream of heat exchanger 50. The secondary EGR valve 68 is positioned at the intersection of EGR conduit 38 and secondary exhaust conduit 66, and is configured to selectively cut-off the flow of exhaust gas through the EGR system 58 and to provide venting of exhaust gas out of the EGR system and into the exhaust system of the engine. That is, in a first position, secondary EGR valve 68 cuts-off the flow of exhaust gas through the EGR system 58 upstream of heat exchanger 50 and diverts the exhaust gas to the secondary exhaust path 66 and into the exhaust system of the engine so as, for example, to further treat the exhaust gas before venting to the atmosphere. In a second position, secondary EGR valve 68 allows for the flow of exhaust gas to continue through the EGR system 58.

The selective opening and closing of EGR valve 62 and intake valve 64 (and of secondary EGR valve 68), and the corresponding termination of the flow of exhaust gas through the EGR system 58 and injection of ambient air into the EGR system 58, allows for the selective operation of EGR compressor 46 as a standard compressor and as a supercharger. That is, when EGR valve 62 is in an open position and intake valve 64 is closed (and secondary EGR valve 68 is in the second position), the EGR compressor 46 is supplied with exhaust gas and functions as a compressor to compress the exhaust gas for introduction into the intake manifold 16 of the engine 12. Conversely, when the intake valve 64 is an open position and EGR valve 62 is closed (and secondary EGR valve 68 is in the first position), EGR compressor 46 is supplied with ambient air and functions as a “supercharger” to compress the ambient air for introduction into the intake manifold 16 of the engine 12. The operation of EGR compressor 46 as a supercharger for part loads, cold start, and transient operation of the engine 12 provides a reduction in specific fuel consumption and an increase in volumetric efficiency of the engine, as well as improved transient and cold start behavior.

As further shown in FIG. 2, an exhaust valve 70 (i.e., throttle) is included in the internal combustion engine system 10 and positioned upstream of the turbine 24 of turbocharger 22 on the exhaust conduit 20. The exhaust valve 70 provides for a controlled flow of exhaust gas to turbocharger 22 and, correspondingly, controls the amount of exhaust gas diverted to EGR system 58. When exhaust valve 70 is biased to divert a larger amount of exhaust gas to EGR system 58, an increased amount of exhaust gas is passed through the expansion turbine 40. As such, an increased amount of power is extracted from the exhaust gas by expansion turbine 40, and an increased amount of electrical power is generated by generator 44. Beneficially, the increased electrical power generated by generated 44 can be provided to electric motor 56 to power the EGR compressor 46 when it is operated as a supercharger. That is, as the energy required by the supercharger 46 to compress the ambient air to a desired pressure ratio may differ slightly from that required for compressing the exhaust gas, it is desirable to selectively generate increased power from expansion turbine 40 by diverting an increased amount of exhaust gas through the EGR system 58 via use of exhaust valve 70.

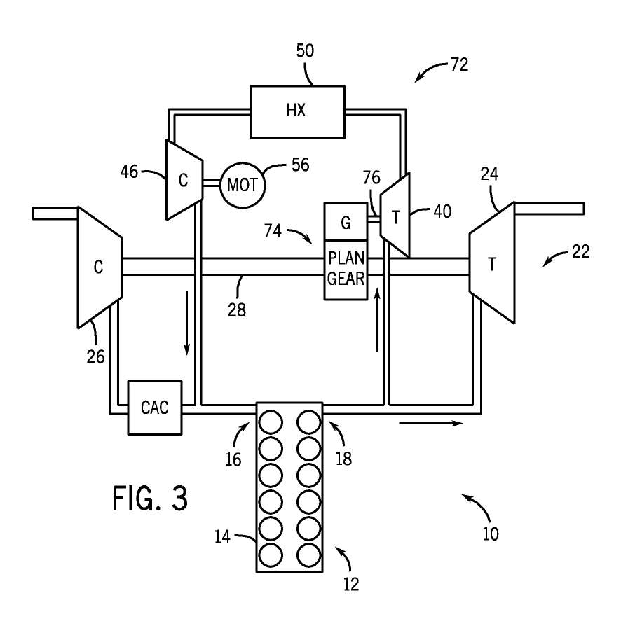

Referring now to FIG. 3, according to another embodiment of the invention, an EGR system 72 is configured such that the mechanical power output generated by the expansion turbine 40 is transferred to a gear system 74 connected thereto by way of a drive shaft 76. The gear system 74 can be configured as, for example, a planetary gear arrangement, although other configurations are also possible. In addition to being connected to expansion turbine 40, gear system 74 is also mechanically connected/coupled to drive shaft 28 of turbocharger 22. The connection of gear system 74 to both the expansion turbine 40 and the drive shaft 28 allows for the transfer of mechanical power generated by expansion turbine 40 to be transferred to the drive shaft 28 of turbocharger 22. In such an arrangement, the amount of power available to turbocharger 22 is thus increased by passing exhaust gas through expansion turbine 40 of the EGR system 72 to generate power and then transferring that power to the drive shaft 28 by way of the gear system 74. The increased power available to turbocharger 22 provides performance benefits in internal combustion engine system 10.

In various other embodiments, the system 10 can comprise other components such as additional valves, particulate filters, exhaust treatment devices (e.g., catalytic converters and NOₓ traps), sensors, and the like. The arrangement of these components within the system varies depending on the application and is readily understood by those in the art.

Advantageously, the systems and method disclosed herein reduce NOₓ emissions, while increasing the efficiency of the engine.

The invention has been described in terms of the preferred embodiment, and it is recognized that equivalents, alternatives, and modifications, aside from those expressly stated, are possible and within the scope of the appending claims.

What is claimed is:

1. An exhaust gas recirculation (EGR) apparatus, comprising:
an EGR circuit comprising:
an input configured to receive an exhaust gas from an engine exhaust port;
an output configured to return the exhaust gas to an intake port of the engine; and
an EGR path configured to circulate the exhaust gas between the input and the output;
an expansion turbine connected to the EGR circuit in the EGR path downstream of the input to receive the exhaust gas, the expansion turbine configured to expand the exhaust gas and reduce a pressure thereof; and
an EGR compressor connected to the EGR path downstream of the expansion turbine and decoupled from the expansion turbine, the EGR compressor configured to compress the exhaust gas for circulation to the output.

2. The EGR apparatus of claim 1, further comprising:
a generator connected to the expansion turbine and driven thereby to generate electrical power; and
an electric motor connected to the generator to receive the electrical power therefrom and drive the EGR compressor.

3. The EGR apparatus of claim 1, wherein the electric motor comprises a variable speed motor to selectively drive the EGR compressor to pressurize the exhaust gas to a desired level.

4. The EGR apparatus of claim 1, further comprising a gear system connected to the expansion turbine and driven thereby.

5. The EGR apparatus of claim 4, wherein the gear system comprises a planetary gear configured to transfer mechanical power to a turbocharger shaft.

6. The EGR apparatus of claim 1, further comprising a heat exchanger connected to the EGR path downstream of the expansion turbine and upstream of the EGR compressor to further cool the exhaust gas.

7. The EGR apparatus of claim 1, further comprising:
an air intake circuit having an air intake and coupled to the EGR circuit upstream of the EGR compressor and downstream of the expansion turbine to inject ambient air into the EGR path;
an intake valve positioned in the air intake circuit to control injection of the ambient air into the EGR path; and
an EGR valve positioned in the EGR path upstream of the air intake circuit to control a flow of the exhaust gas to the EGR compressor.

8. The EGR apparatus of claim 7, wherein, when the intake valve is an open position to inject the ambient air into the EGR path and the EGR valve is in a closed position to cut-off the flow of the exhaust gas to the EGR compressor, the EGR compressor comprises a supercharger.

9. The EGR apparatus of claim 1, further comprising an exhaust valve positioned upstream of the expansion turbine to control a flow of the exhaust gas into the EGR circuit.

10. An engine system, comprising:
an engine having an intake manifold and an exhaust manifold;
an exhaust conduit connected to the exhaust manifold to convey an exhaust gas away from the engine;
a turbocharger having a turbine and a compressor driven by the turbine, wherein the turbine is connected to the exhaust conduit to receive the exhaust gas from the exhaust manifold, and wherein the compressor is positioned upstream of, and connected to, the intake manifold; and
an exhaust gas recirculation (EGR) system connected to the exhaust conduit to receive at least a portion of the exhaust gas therefrom, the EGR system comprising:
an EGR conduit connected to the exhaust conduit to receive the at least a portion of the exhaust gas;
an expander connected to the EGR conduit and configured to expand the at least a portion of the exhaust gas and reduce a pressure thereof;
a heat exchanger connected to the EGR conduit downstream of the expander to cool the at least a portion of the exhaust gas; and
an EGR compressor connected to the EGR conduit downstream of the heat exchanger and configured to compress the at least a portion of the exhaust gas for recirculation to the intake manifold of the engine.

11. The engine system of claim 10, wherein the EGR system further comprises a generator-electric motor combination driven by the expander and configured to selectively control driving of the EGR compressor.

12. The engine system of claim 10, wherein the EGR system further comprises a gear system connected to the expander and the turbocharger to transfer a mechanical power output of the expander to the turbocharger.

13. The engine system of claim 10, wherein the EGR system further comprises:
an ambient air intake conduit positioned upstream of the EGR compressor and downstream of the expander to introduce ambient air into the EGR conduit;
an intake valve positioned in the ambient air intake conduit and configured to control injection of the ambient air into the EGR conduit; and
an EGR valve positioned in the EGR conduit and upstream of the ambient air intake conduit and configured to control a flow of the at least a portion of the exhaust gas to the EGR compressor.

14. The engine system of claim 13, wherein during operation of the engine in one of a part load, a cold start, and a transient state, the intake valve is in an open position and the EGR valve is in a closed position to provide ambient air to the EGR compressor.

15. The engine system of claim 14, wherein during operation of the engine in one of the part load, the cold start, and the transient state, the EGR compressor comprises a supercharger configured to compress the ambient air.

16. The engine system of claim 10, further comprising an exhaust valve positioned in the exhaust conduit upstream of the turbine to selectively control a flow of another portion of the exhaust gas to the turbocharger turbine.

17. The engine system of claim 10, further comprising:
an ambient air conduit connected to the turbocharger compressor and configured to transfer ambient air to the intake manifold; and
a charge air cooler connected to the ambient air conduit and positioned between the turbocharger compressor and the intake manifold, the charge air cooler configured to cool the ambient air.

18. A method, comprising:
conveying exhaust gas from an exhaust manifold of an internal combustion engine to an exhaust gas recirculation (EGR) system;
expanding the exhaust gas in an expansion turbine in the EGR system to lower a temperature and to generate a mechanical power output;
selectively transferring the expanded exhaust gas to an EGR compressor in the EGR system positioned downstream from the expansion turbine;
compressing the exhaust gas in the EGR compressor to a desired pressure independently of the mechanical power output of the expansion turbine; and
recirculating the compressed exhaust gas to an intake manifold of the internal combustion engine.

19. The method of claim 18, further comprising:
driving a generator connected to the expansion turbine with the mechanical power output;
supplying electrical power from the generator to an electric motor; and
driving the EGR compressor with the electric motor.

20. The method of claim 18, further comprising conveying exhaust gas from the exhaust manifold of the internal combustion engine to a turbocharger, the turbocharger including a turbine, a compressor, and a drive shaft connecting the turbine to the compressor.

21. The method of claim 20, further comprising:
driving a gear system connected to the expansion turbine with the mechanical power output; and
providing mechanical power to the drive shaft of the turbocharger through the gear system.

22. The method of claim 18, further comprising actuating an air intake valve to selectively inject ambient air into the EGR system at a location upstream from the EGR compressor and downstream from the expansion turbine.

23. The method of claim 18, further comprising actuating an EGR valve to selectively cut-off a flow of the exhaust gas through the EGR system at a location upstream from the EGR compressor and downstream from the expansion turbine.
